(19) United States
(12) Patent Application Publication
(10) Pub. No.: US 2014/0202574 A1
(43) Pub. Date: Jul. 24, 2014

(54) UMBILICAL WITH FATIGUE RESISTANT FIBRES

(71) Applicant: Fraser Hynd Thomson, Kinross (GB)

(72) Inventor: Fraser Hynd Thomson, Kinross (GB)

(73) Assignee: OCEANEERING INTERNATIONAL SERVICES LIMITED, Fife (GB)

(21) Appl. No.: 14/125,935

(22) PCT Filed: Jun. 13, 2012
(86) PCT No.: PCT/GB2012/000516

§ 371 Date: Mar. 21, 2014

(30) Foreign Application Priority Data
Jun. 13, 2011 (GB) 1109869.6

(51) Int. Cl. F16L 11/08

(52) U.S. Cl. CPC F16L 11/082; F16L 11/086
USPC 138/125; 138/130; 138/137; 156/172

(57) ABSTRACT

An umbilical casing for an umbilical, for use in underwater drilling operations includes an inner thermoplastic polymer layer, an outer thermoplastic polymer layer and at least two fibre reinforcement layers between the inner and outer thermoplastic layers. The fibre reinforcement layers are contra helical with each including at least one group of fibre yarns laid helically along the outside of the inner thermoplastic layer. Each group of fibre yarns comprises a plurality of fibre yarns laid to run in side by side fashion along the outside of the inner thermoplastic layer. An umbilical including the casing and methods of manufacture are also provided.

### FIELD OF THE INVENTION

The present invention relates to a conduit for transporting fluids, particularly hydrocarbon fluids or hydraulic fluids, and particularly to a fluid conduit or hose, sometimes referred to as an umbilical, for use in offshore drilling environments.

### BACKGROUND TO THE INVENTION

In offshore drilling environments it is necessary to supply hydraulic signals and fluids to the wellhead and the standard practice up until relatively recently has been to use a standard thermoplastic hydraulic sub-sea control umbilical hose for the purpose of work over control where work over operations are performed on a sub-sea wellhead using a work over riser or for blow out preventer control and actuation.

The umbilical is a conduit that can contain a number of hoses for carrying fluid and may also carry electrical cabling and fibre optic cabling as required. Typically hoses and cables carried within an umbilical are of multilayer reinforced structures, such as are known in the art so that they have appropriate pressure containment, burst and compression resistance for the usage envisaged. The umbilical provides a convenient single conduit to carry the fluid, electrical and signalling requirements of the task in hand.

Normally these umbilical's are stored, deployed and recovered from hydraulic or air powered reels on the topside (surface of the water).

Such umbilicals are deployed, operated and recovered through a route containing one, two or three sheaves (wheels or rollers) depending on the applications and the heave compensation systems used.

The umbilicals are subjected to various tensile and bending loads during deployment, operation and recovery whilst paid off and paid onto the reel, over various sheaves, roller guides and heave compensation system. These sheaves are typically plain rotating)(360° sheaves or fixed static sheaves (180° with multiple rollers on the periphery which are free to rotate.
When in place and operational the umbilicals are subject to fatigue motions comprising relatively small displacements (“to and fro” motions). However these fatigue motions occur in a high number of cycles, which can lead to wear of the component parts of the umbilical.

Over the last 15 years, there has been a move to develop and recover oil reserves from deeper and deeper waters and as a result, work over and BOP (blow out preventer) umbilical's are longer due to the increased distances from the topside to the wells furthermore, these systems are more critical in terms of functionality and performance due to the increased costs for these associated activities.

Also these products are now expected to have more reliability with longer design and operational lives to maximise the value and reusability of the assets. Accordingly, fatigue levels are higher and improved design life and performance is required.

With increasing water depths, greater demands from heave compensation systems, more intelligent operational performance for constant tension umbilical reeler systems, loads are now higher and bending fatigue is greater. End users often expect to reuse these systems on more vessels and wells than before and expect longer design lives which have typically increased from 5 years, to around 10 to 15 years.

These tensile loads are taken up by tensile reinforcement within the umbilical usually applied to the umbilical towards the outside of the structure, for example on the outside of an inner layer of an extruded plastic such as a thermoplastic polyurethane. The tensile reinforcement may be supplied via contra-helically served layers or single or multiple braided layers of high strength fibre—typically aramid fibres are employed.

This reinforcement is also required to cope with the single and reverse bending fatigue predominantly during deployment and retrieval fatigue due to multiple reployment and recovery over service life. Operational fatigue is caused by the relative motions of the vessel or topside structure and the subsea well on the seabed.

During operation an umbilical can be subject to many tens of thousands of fatigue cycles with varying degrees of cyclic bending and tensile strains. As the required performance for umbilicals increases there is a need for improved umbilical structures to provide satisfactory performance under harsher conditions for extended periods of time.

### DESCRIPTION OF THE INVENTION

According to a first aspect the present invention provides an umbilical casing for an umbilical for use in underwater drilling operations, the umbilical casing comprising:
an inner thermoplastic polymer layer;
an outer thermoplastic polymer layer; and
at least two fibre reinforcement layers between the inner and outer thermoplastic layers; wherein the fibre reinforcement layers are contra helical with each comprising at least one group of fibre yarns laid helically along the outside of the inner thermoplastic layer,

Each group of fibre yarns comprises a plurality of fibre yarns laid to run in side by side fashion along the outside of the thermoplastic layer.

The two fibre reinforcement layers run contra helically to each other (“clockwise” and “counterclockwise”) and may be adjacent, typically in contact with, each other. The contra helical arrangement provides a torque balanced system, not tending to twist the umbilical, when a tensile load is applied, as a consequence of the helical winding of the groups of fibre yarns.

The fibre reinforcement layers may be arranged to provide a complete fibre covering to the inner thermoplastic polymer layer. For example each pitch or lay length (turn) of the helix of the group of fibre yarns in a layer of fibre reinforcement may be adjacent and in contact with the next. This arrangement is applied when it is desired to maximise the tensile strength and fatigue performance provided by the fibre layers.

However for many applications it is advantageous if both layers of fibre reinforcement comprise at least one group of fibre yarns laid helically along the outside of the inner thermoplastic polymer layer, with each pitch or lay length (turn) of the helix being spaced apart from the next. The spacing apart of the fibre yarns reduces abrasion between fibre yarns as the amount of contact is reduced. It can provide other advantages as described below.

The fibre reinforcement layers may each comprise a plurality of groups of fibre yarns with each group of fibre yarns in a layer being radially displaced about the inner thermoplastic polymer layer, so that groups of fibre yarns are spaced apart as they run along the outer surface of the inner thermoplastic layer. Thus when two layers of fibre reinforcement run contra helically, the outer surface of the inner thermoplastic layer is not completely covered but is provided with spaces between the groups of fibre yarns, of a generally diamond (rhombus) shape.

The two (or more) layers of fibre reinforcement running contra helically may be laid in a braided fashion, with groups of fibre yarns running in opposite directions passing over and under each other in a “woven” fashion. As noted above it is advantageous if the groups of fibre yarns are spaced apart, whereupon a braided arrangement will provide an “open weave” effect.

Advantageously the contra helical layers are not braided; each layer may be simply laid down on top of the next. This arrangement has the benefit of being simpler to apply and reducing the wear due to tension between interwoven fibre yarns.

Typically the lay angle of the groups of fibre yarns is between 10 and 20 degrees with respect to the axial direction of the casing. This can provide the required axial strength together with good resistance to bending fatigue.

Advantageously the outer thermoplastic polymer layer is bonded to the inner thermoplastic polymer layer. For example, the inner and outer thermoplastic layers are generally formed into tubing by extrusion processes. After formation of the inner layer the fibre reinforcement layers are applied and then the outer thermoplastic polymer layer is extruded onto the inner layer. By providing spaces between groups of fibre yarns and by selecting appropriate extrusion conditions for the outer thermoplastic polymer layer (temperature and pressure conditions and avoiding oxidation of the inner layer), the outer layer is bonded by fusing to the inner layer. By bonding together the thermoplastic polymer layers the groups of fibre yarns in the spaces between the bonded areas are encapsulated. This encapsulation reduces relative movement between the fibres themselves and between the fibres and the polymer layers.

The two thermoplastic polymer layers may be of the same or different polymers. Typically they are of the same polymer, which ensures good fusion when the outer layer is extruded and bonded to the inner layer. Typical prior art umbilical casings make use of polyurethane for casing layers. However such polymers have been found to tend to abrade fibre typical reinforcing layers, such as Aramid fibres. Aramid fibres are used extensively in underwater application, such as umbilicals because they can provide the required mechanical properties, axial stiffness and strength. However, they have generally poor self abrasion resistance (fibre to fibre) as well as poor abrasion resistance to casing polymer material.

Advantageously the inner and outer thermoplastic polymer layers comprise or consist of a polyether block amide (PEBA) thermoplastic elastomer. Such polymers have been found to provide reduced wear to fibres such as Aramid used in fibre reinforcing layers as discussed in more detail hereafter. Suitable PEBA materials are commercially available, for example under the trade name Pebax®, available from Arkema.

Aramid fibre has typically been used for umbilical casing applications in the past, but it is incapable of withstanding the fibre on fibre abrasion now required for the flex fatigue cycle life of the umbilical. The fibre wears when the umbilical is flexed and also when flexed whilst under tension. The abrasion is caused by a number of factors including,
adjacent fibres abrasion on each other;
adjacent fibre layers (wearing because of relative transverse movement)
abrasion against underlying or overlaying polymeric jackets and tape layers.

Advantageously the fibre reinforcement layers of the present invention make use of alternative fibres. Suitable fibres, that have been found to have improved abrasion resistance for the current application include:
liquid crystal polymers (LCP) such as aromatic or wholly aromatic polyesters, such as the commercially available Vectran™ fibres available from Kuraray Co., Ltd, for example made from condensation of 4-hydroxybenzoic acid and 6-hydroxynapthalene-2-carboxylic acid;
Ultra high molecular weight polyethylene (UHMWPE) such as the Spectra® and Dyneema® spun fibres available from Honeywell Speciality Materials and Royal DSM N.V. respectively; and
poly(p-phenylene-2,6-benzobisoxazole) (PBO) (trade name Zylon® from Toyobo Corporation).

Vectran fibres have been found to give particularly good performance as discussed hereafter and can be of similar cost to aramid fibres.

Fibre yarns are generally twisted to provide the optimum tensile strength. The yarn may be single ply, having a bundle of untwisted fibres that are twisted together to the desired degree. Alternatively a yarn may be two or more ply, where already twisted yarns are themselves twisted together to form a yarn that has two or more strands or plies. For the present invention single ply yarns are preferred as the yarn then has a relatively smooth, generally cylindrical outer surface and hence improved abrasion performance. A plied yarn has a more uneven outer surface and so can result in increased abrasion when rubbed against another surface (another yarn or surface of a polymer layer in the umbilical casing).

Typically the amount of twisting applied to a yarn to maximise the tensile strength of the material is expressed as the twist multiplier. A twist multiplier of 1.1 is normally applied. The twist multiplier is found in the equation below.

$$tpm = \frac{1.1 \times 960}{\sqrt{tex \times no . of plies}}$$

Wherein tpm is the number of twists per metre of the yarn; and tex is a measure of the linear mass density of the fibres expressed in g/1000 m.

Surprisingly it has been found that the abrasion resistance of a yarn can be improved by increasing the amount of twist to a yarn, when using fibre types suitable for a fibre reinforcement layer of the present invention. A twist multiplier of more than 1.1, for example from 2.0 to 4.0, or even 2.5 to 3.5 can provide improvement.

An approximately 3 times greater than standard twist multiplier has been shown to be highly beneficial in some respects. For example in tests a yarn having a nominal twist multiplier of 3.3 may be capable of providing about 10 times improvement in fibre to polymer abrasion resistance (aramid with 3× standard twist vs. aramid yarn with standard twist). For example in tests a yarn having a nominal twist multiplier of 3.3 may be capable of providing about 22 times improvement in fibre to fibre abrasion resistance (LCP—Vectran yarn with 3× standard twist vs. Vectran yarn with standard twist).

Applying additional twist to a yarn is known to reduce tensile strength of a yarn, but applying a twist multiplier in excess of the standard 1.1, for example about 3.3 has been found to reduce ultimate tensile strength by an amount of the order of 10 to 20%. This loss of tensile strength in exchange for the improvement in abrasion resistance can be acceptable in many circumstances.

Typical performance curves for yarn axial strength properties are given below in Scheme 1. The scheme shows the increase then decline in Tenacity (tensile breaking strength per unit of linear mass density) with increasing twist multiplier. At the same time the modulus (axial stiffness or stress/strain) declines whilst the elongation to breaking point tends to increase slightly.

It will be understood that the umbilical casing may comprise additional layers of selected materials in order to improve performance. For example further layers of thermoplastic polymer, which may be separated from the inner and outer layers by further fibre reinforcement layers, may be used to increase the strength and durability of the casing. Other layers may be present, for example a thin innermost layer may be provided to act as a wrapping for the hoses, cables etc to be carried within the conduit.

In addition to encapsulation within the inner and outer thermoplastic polymer layers, optimising lay angle and spacing groups of fibre yarns as discussed above, fatigue performance of the fibre reinforcement may also be improved by separating fibre yarns physically from each other, by other means. For example a layer of material such as polyethylene may be used to separate the two fibre reinforcement layers. This may be provided in the form of a tape for example or may be provided as a further layer of extruded polymer between the two fibre reinforcement layers.

Improvement with respect to abrasion may also be achieved by using alternating materials, within a fibre reinforcement layer and/or between fibre reinforcement layers. For example aramid fibre yarns in a group of fibre yarns may alternate with a low friction fatigue resistant fibre yarn such as the LCP, PBO and UHMWPE yarns discussed before, in the same group. Alternatively each fibre yarn or alternate fibre yarns in a group may be sheathed with a lower friction material for example a polyethylene or polyether block amide (PEBA).

According to a second aspect the present invention provides an umbilical for use in underwater drilling operations, the umbilical comprising an umbilical casing according to the first aspect of the invention.

Inside the casing, the umbilical may further comprise one or more reinforced hoses for carrying fluid, and/or one or more electrical cables and/or one or more fibre optic cables. the umbilical may also be provided with a filler material to fill spaces between the hoses and cables carried within the casing. The filler material may be of an elastomer, a soft elastomer such as a thermoplastic vulcanizate (TPV), for example Santoprene™ TPVs available from Exxon Mobile Chemical, may be employed. The filler material may be provided in the form of rods that may be of different diameters. The rods are a convenient way of filling up unused space inside and along the length a casing of a given size and carrying a given set of hoses and/or cables. By filling or substantially filling the casing, greater crush resistance is provided. Making use of soft compliant fillers has the advantage that the filler material will have a greater contact area on operational components such as hoses and cables, reducing the potentially damaging contact pressures.

According to a third aspect the present invention provides a method of forming an umbilical casing comprising:
providing a first, inner, extruded tubular layer of a thermoplastic polymer;
laying at least two contra helically wound fibre reinforcement layers around the first layer of thermoplastic polymer; and
extruding a second, outer, layer of thermoplastic polymer onto the first layer and the two fibre reinforcement layers;
wherein the fibre reinforcement layers each comprise at least one group of fibre yarns laid helically along the outside of the inner thermoplastic layer; and
wherein each group of fibre yarns comprises a plurality of fibre yarns laid to run in side by side fashion along the outside of the first, inner, thermoplastic layer.

The method may include the provision of further layers and umbilical contents as discussed above with respect to the first and second aspects of the invention. The fibre reinforcement layers and thermoplastic polymer layers may be provided in accordance with any of the options discussed above with respect to the first and second aspects of the invention.

Typically the reinforcement layers are applied in either a contra helical lay using a spiral winder planetary layup machine or where a braided construction is desired by using a maypole braiding machine of typically 24 or 36 bobbins

### DESCRIPTION OF SOME PREFERRED EMBODIMENTS AND EXPERIMENTAL RESULTS

### Brief Description of the Drawings

FIG. 1 shows in schematic plan an arrangement of helically laid fibre reinforcement layers for use in an umbilical casing of the invention;

FIG. 2 shows in schematic plan a braided arrangement of fibre reinforcement layers for use in an umbilical casing of the invention; and

FIG. 3 shows in schematic cross section an umbilical in accordance with the invention.

### DESCRIPTION OF THE DRAWINGS

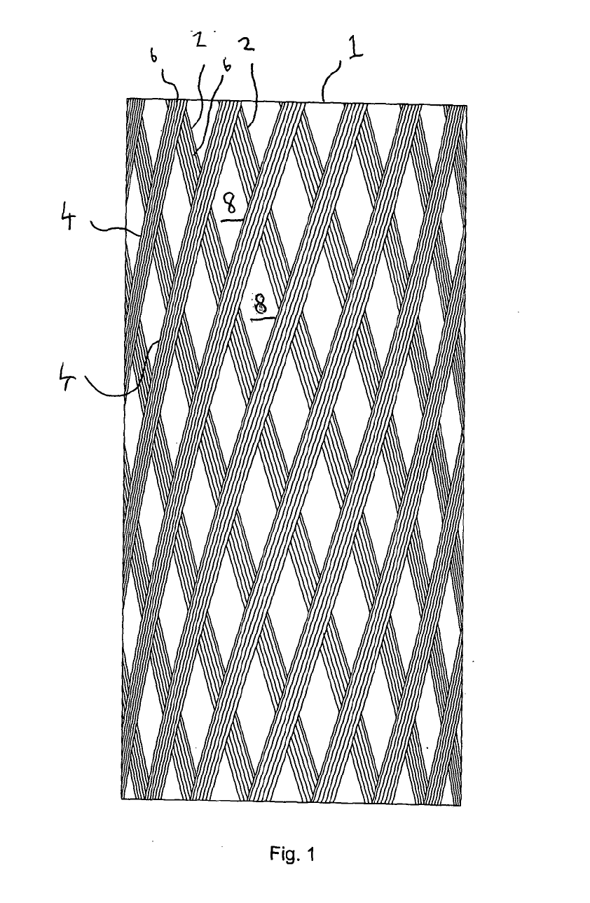

In FIG. 1 a section of an inner thermoplastic layer 1 in the form of elongate tubing for use in an umbilical casing is shown in plan view. Two contra helically wound fibre reinforcement layers are shown. A lower layer has groups 2 of fibre yarns 6 running helically and spaced apart the thermoplastic layer 1. An upper layer has groups 4 of fibre yarns 6 running contra helically to those of the lower layer and in spaced apart fashion. Spaces 8 are thus provided between the groups 2,4 of fibre yarns.

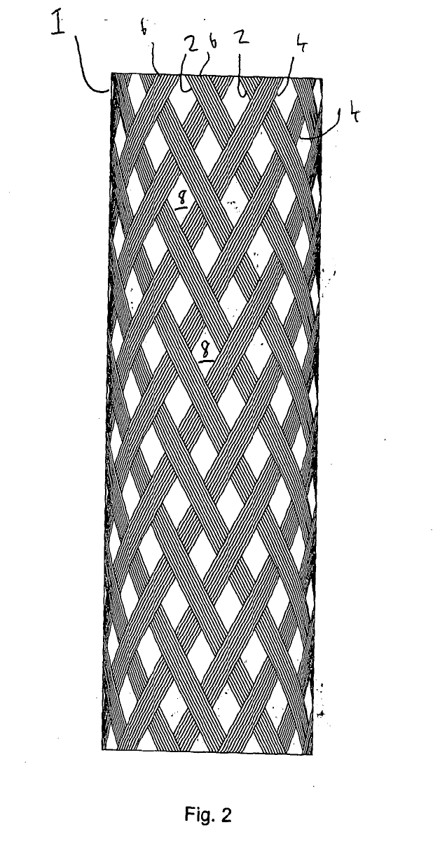

FIG. 2 shows an alternative arrangement, similar to that of FIG. 1 except that the groups 2, 4 of fibre yarns are braided together. Thus the two layers of contra helical groups of fibre yarns may be considered to be interwoven to form one interlinked layer of fibre reinforcement. In this example each group of fibre yarns (of reference number 2 or 4) passes over two groups of the fibre yarns running contra helically then under the next two and so on to give the particular pattern shown. Alternative weaving patterns may be applied to vary the degree of interconnection between the layers.

The groups of fibre yarns comprise several (six shown in FIGS. 1 and 2) fibre yarns 6 laid side by side. The fibre yarns are preferably of a Vectran fibre with a twist multiplier of 3.3. For example the fibre yarns may be formed as follows. Four bundles of parallel microfilaments are used. A suitable grade is Vectran type HT of 1670 dtex (decitex). The bundles have been folded together (collected in a single bundle) and twisted into a single ply yarn.

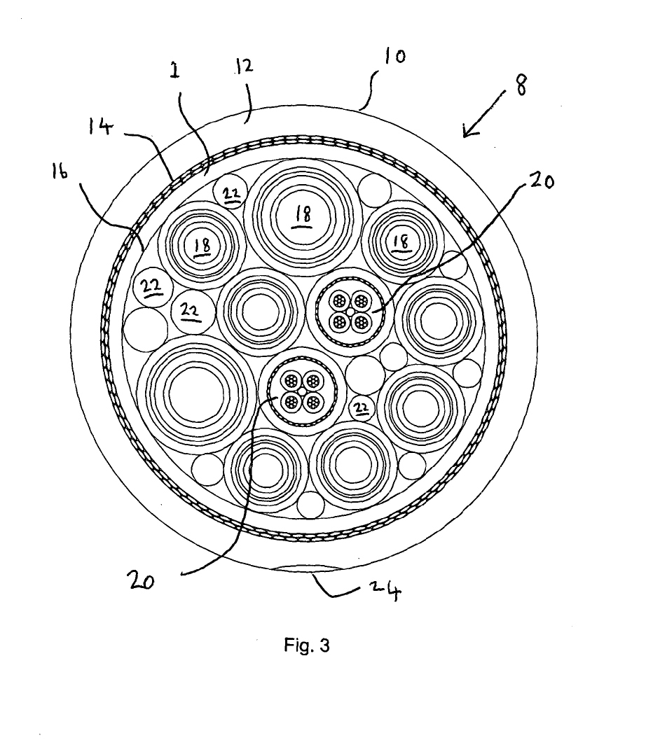

FIG. 3 shows in schematic cross section an umbilical 8. The umbilical 8 has a casing 10. The casing 10 has an inner thermoplastic polymer layer 1 (of a polyether block amide (PEBA) thermoplastic elastomer) and an outer thermoplastic polymer layer 12 of the same material. Between the polymer layers 1,12 are two fibre reinforcement layers 14, made up in similar fashion to that shown in FIG. 1. The outer polymer layer 12 has been extruded onto the fibre reinforcement layers 14 and by virtue of spaces 8 (FIG. 1) and use of appropriate temperature and pressure conditions (about 210° C. and 900-1000 psi for example) during the extrusion process the thermoplastic polymer layers 1,12 are fused together, encapsulating the Vectran fibre reinforcement layers, which are “non-stick” with respect to the PEBA. The casing 10 is completed in this example by a thin layer of a fibre tape wrapping 16 inside the inner polymer layer and around the content of the umbilical casing 10. The content of the casing 10 is a bundle of reinforced hoses and electrical cables. Reinforced hoses (resisting crushing and bursting) 18 of different diameters are each indicated by concentric circles showing the number of layers in their construction (e.g. layers of extruded polymer, polymer fibre or metal reinforcement). Two armoured four core electrical cables 20 are shown in this example. The content of the casing 10 is completed by rods 22 of elastomer (such as Santoprene™), of varying diameter. The rods 22 fill the spaces between hoses, cables and the casing 10 to form a crush resistant package inside the casing 10.

The umbilical of FIG. 3 is manufactured by wrapping the bundle of hoses 18, cables 20 and rods 22 in the fibre tape wrapping 16 and then extruding the inner polymer layer on top. The two fibre reinforcement layers 14 are then applied as discussed above with respect to FIG. 1. Finally the umbilical is completed by extruding the outer thermoplastic layer 12 onto the two fibre reinforcement layers 14 and the inner thermoplastic layer 1 as described above. A lay line marking 24 is provided on the outside surface of the outer thermoplastic layer 12, along the length of the umbilical 8.

A typical umbilical such as that shown in FIG. 3 may have a diameter of the order of 70 to 120 mm with the casing inner 1 and outer 12 polymer layers having thicknesses of the order of 2.5 mm and 5 mm respectively.

### Materials Testing

Comparative tests were carried out as discussed below. In order to provide meaningful comparison of differences in performance resulting from choice of material or choice of twist multiplier, yarns of different materials and/or twist multiplier were considered against yarns of similar dimensions (tex) when reporting results.

### 1. Abrasion Testing of Fibre Yarn on Thermoplastic Polymer (Umbilical Casing Material).

Selected yarns and polymer material were rubbed together on a test rig. The test yarn was tensioned over part of the circumference of a sample tube of the polymer material and repeatedly moved back and forwards until failure (breakage of the yarn) or an acceptable minimum number of cycles had been completed. (25 mm travel for the test yarn; 1 cycle per 11 seconds; and 0.9 Kg tension were used).

### Polyurethane

For an aramid yarn (Kevlar 956C) on a standard umbilical polymer material (polyurethane) a 10× (ten times) improvement (number of cycles to failure) was observed for a yarn with a 3.3 twist multiplier in comparison with the same yarn with a 1.1 (standard) twist multiplier.

LCP (Vectran HT 190) yarns, even with the standard twist multiplier, showed more than a 257× improvement over the aramid when tested on the same polyurethane. The testing of both standard twist and over twisted (3.3 twist multiplier) yarns was stopped due to a high number of cycles being achieved without failure and only limited damage visible.

UHMWPE (Spectra 1000) yarn also showed improvement over aramid on testing on polyurethane (>17× with testing stopped before failure).

### PEBA

Testing abrasion resistance of yarns on PEBA (Pebax®) demonstrated significantly reduced abrasion in comparison with the tests carried out on polyurethane. Aramid (standard twist Kevlar 956C) on Pebax 5033 and 4033 grades had >67× and >10× improvement over the results on polyurethane.

Similarly Vectran HT (standard twist and over twisted), on Pebax 4033 outperformed standard and over twisted aramid by >26×.

### 2. Fibre on Fibre Abrasion Testing (Parallel)

The abrasive action of side by side and in contact fibre yarns was assessed by providing, in a test rig, a fixed fibre yarn with an adjacent and generally parallel moving fibre yarn. The moving yarn was wrapped twice (two turns) round the fixed yarn to ensure good fibre to fibre contact.

The two yarns were separately tensioned over part of the circumference of a tube covered in a very low friction tape. The moving yarn was then repeatedly moved back and forwards until failure (breakage of either yarn) or an acceptable minimum number of cycles had been completed. (25 mm travel; 1 cycle per 11 seconds; and tensions of 2 Kg for the fixed yarn, 4 kg for the moving yarn).

In these tests both yarns in each test were of the same material (e.g. both yarns were of Kevlar 956C or both of Vectran HT190 etc).

In testing Vectran HT 190 yarns of standard twist multiplier (1.1) had 6× better performance than aramid (Kevlar 956C) of standard twist multiplier. Remarkably Vectran HT 190 yarn of twist multiplier 3.3 had a 132× improvement in performance over the aramid fibre.

### 3. Fibre on Fibre Abrasion Testing (Shear)

These tests were carried out to test fibre on fibre abrasion when the fibre yarns rubbing against each other are in a crossing, rather than in a side by side relationship. For example where two layers of fibre yarn are running contra helically.

A fixed fibre yarn was located axially on the surface of a tube covered in a very low friction tape material. The fixed yarn was held under tension.

A moving fibre yarn was then tensioned over the fixed yarn and part of the circumference of the tube and repeatedly moved back and forwards until failure (breakage of the yarn) or an acceptable minimum number of cycles had been completed. (25 mm travel; 1 cycle per 11 seconds; 1.7 Kg tension for the moving yarn, 2 kg tension for the fixed yarn were used).

On testing Vectran HT 190 yarns of standard twist multiplier (1.1) outperformed Kevlar 956C of standard twist multiplier by a factor of 4×.

Over twisting (twist multiplier 3.3) the Kevlar 956C gave a 6× improvement over the standard twist Kevlar.

Over twisting (twist multiplier 3.3) the Vectran HT 190 provided a >50× improvement over the standard twist Kevlar. The test was stopped after a high number of cycles with little fibre damage observed.

### 4. Compression (Radial) Testing

Fibre yarns were tested for resistance to crushing (a crushing force is applied to a yarn when an umbilical casing is being run over a roller sheave).

In the test a crushing force was applied to radially to yarns placed between two layers of Pebax 4033 (2 mm and 4 mm thick). The force was applied at 300N, increased to 3000N and then reduced back to 300N for 3000 cycles. The change in tensile breaking strength of the yarns was measured before and after crushing.

An aramid yarn (Technora T200 from Teijin Limited) had a reduction of 58% in tensile strength following crushing. In contrast standard twist multiplier Vectran HT 190 showed a reduction in tensile strength of only 28% and an over twisted Vectran HT 190 (twist multiplier 3.3) showed no reduction in tensile strength after crushing.

### 5. Compression (Axial) Testing

Fibre yarns were also subjected to an axial compression test. A test length of yarn was forced through a solid rubber block, using a needle as in sewing. Thus the test length is gripped radially as a consequence of the elasticity of the rubber. The rubber block was then compressed (10 mm over 40,000 cycles) in the axial direction with respect to the test length of yarn. The change in tensile breaking strength of the yarn, before and after the compression was measured.

Both aramid and Vectran yarns showed comparable reductions in tensile breaking strength following the axial compression.

The above series of tests show the benefits obtainable by making use of the preferred umbilical casing thermoplastic polymer layers and/or fibre yarn materials and/or twist multiplier factors.

Each feature disclosed in the above description and (where appropriate) the claims and/or drawings may be provided independently or in any appropriate combination.

1. An umbilical casing for an umbilical for use in underwater drilling operations, the umbilical casing comprising:
an inner thermoplastic polymer layer;
an outer thermoplastic polymer layer; and
at least two fibre reinforcement layers between the inner and outer thermoplastic layers; wherein the fibre reinforcement layers are contra helical with each comprising at least one group of fibre yarns laid helically along the outside of the inner thermoplastic layer; and
wherein each group of fibre yarns comprises a plurality of fibre yarns laid to run in side by side fashion along the outside of the inner thermoplastic layer.

2. An umbilical casing according to claim 1 wherein at least one of the fibre reinforcement layers comprises or consists of fibre yarns that comprise or consist of fibres selected from the group consisting of:
liquid crystal polymers;
ultra high molecular weight polyethylene; and
poly(p-phenylene-2,6-benzobisoxazole).

3. An umbilical casing according to claim 2 wherein at least one of the fibre reinforcement layers consists of fibre yarns that consist of fibres selected from the group consisting of:
liquid crystal polymers;
ultra high molecular weight polyethylene; and
poly(p-phenylene-2,6-benzobisoxazole).

4. An umbilical casing according to claim 1 wherein at least one fibre yarn has a twist multiplier of from 2.0 to 4.0.

5. An umbilical casing according to claim 1 wherein the inner and outer thermoplastic polymer layers comprise or consist of a polyether block amide (PEBA) thermoplastic elastomer.

6. An umbilical casing according to claim 1 wherein the outer surface of the inner thermoplastic layer is provided with spaces between the groups of fibre yarns.

7. An umbilical casing according to claim 6 wherein the inner and outer thermoplastic polymer layers are bonded together by fusion at spaces between the groups of fibre yarns.

8. An umbilical casing according to claim 1 wherein the two fibre reinforcement layers are adjacent and in contact with each other.

9. An umbilical casing according to claim 1, wherein the fibre reinforcement layers are be arranged to provide a complete fibre covering to the inner thermoplastic polymer layer.

10. An umbilical casing according to claim 1 wherein the at least two fibre reinforcement layers are laid in a braided fashion.

11. An umbilical casing according to claim 1 wherein the at least two fibre reinforcement layers are laid one on top of the other without braiding.

12. An umbilical casing according to claim 1 wherein at least one of the fibre reinforcement layers comprises or consists of an aramid fibre.

13. An umbilical casing according to claim 1 wherein the fibre yarns are single ply.

14. An umbilical for use in underwater drilling operations, the umbilical comprising an umbilical casing according to claim 1.

15. An umbilical according to claim 14 further comprising, as filler material a thermoplastic vulcanizate.

16. A method of forming an umbilical casing comprising:
providing a first, inner, extruded tubular layer of a thermoplastic polymer;
laying at least two contra helically wound fibre reinforcement layers around the first layer of thermoplastic polymer; and
extruding a second, outer, layer of thermoplastic polymer onto the first layer and the two fibre reinforcement layers;
wherein the fibre reinforcement layers each comprise at least one group of fibre yarns laid helically along the outside of the inner thermoplastic layer; and
wherein each group of fibre yarns comprises a plurality of fibre yarns laid to run in side by side fashion along the outside of the first, inner, thermoplastic layer.
